(19) United States
(12) Patent Application Publication
(10) Pub. No.: US 2014/0316821 A1
(43) Pub. Date: Oct. 23, 2014

(54) IMPROVEMENTS RELATING TO DECISION SUPPORT

(71) Applicants: Allan Sheffield, North Melbourne (AU); Leslie Sheffield, North Melbourne (AU)

(72) Inventors: Allan Sheffield, North Melbourne (AU); Leslie Sheffield, North Melbourne (AU)

(73) Assignee: GENESFX HEALTH PTY LTD, North Melbourne, Victoria (AU)

(21) Appl. No.: 14/345,365

(22) PCT Filed: Sep. 15, 2012
(86) PCT No.: PCT/AU2012/001102

§ 371 Date: Mar. 17, 2014

Related U.S. Application Data
(60) Provisional application No. 61/535,096, filed on Sep. 15, 2011.

(51) Int. Cl. G06F 19/00

(52) U.S. Cl. CPC G06F 19/345
USPC 705/3

(57) ABSTRACT

A computer-implemented method which comprises outputting by a server device a clinical decision interface, the decision interface for display by a client device; receiving by the server device information comprising: patient information and patient treatment information; processing the information to identify a preferred treatment option and recommending at least one such treatment option.

### BACKGROUND OF THE INVENTION

Since the mapping of the human genome in 2003, the pace of discovery, product development, and clinical adoption of personalised medicine has accelerated. The first application of personalised medicine is pharmacogenomics. Pharmacogenomics (PGx) explains how an individual's genetic make-up affects the way a person responds to medication.

Adverse drug events (ADEs) including adverse drug reactions (ADRs) and slow response to medications have a direct relationship to length of stay in hospitals and the efficiency with which patients are treated in the hospital environment. As an example, in Australia, reduction in the number of ADEs has great potential for reducing the health and hospital costs, especially in an ageing population. General practitioners report that 10% of patients experience ADRs, of which 45% are rated as moderate to severe, and 7.6% resulted in hospitalisation. ADRs can be prevented by testing individuals for genetic variations indicating their susceptibility to toxic reactions.

The current model of pharmaceutical care is a “one size fits all” when it comes to prescribing, not taking into account individual differences in the rate of drug metabolism. To date there has been no simple method or technology available to determine whether people will respond well, poorly, or not at all to a particular medication.

As a result, doctors must use ‘trial and error’ or empirical methods to find the drug that works best for the patient. Often, a patient must return to their doctor repeatedly until the doctor can find a drug that is right for them. Patients often discontinue therapy as a result of side effects or frustration. The technological inability to identify which patients will respond to which medicines significantly limits the optimal use of pharmaceuticals.

The science of pharmacogenomics is identifying specific drugs and clinical situations where genetic testing can limit the above suboptimal responses. Traditional drug safety practices do not incorporate the new field of pharmacogenomics due to lack of expertise and lack of expert systems to integrate complex genetic factors with current prescribing guidelines.

A Pharmacogenomic Decision Support Systems (PDSS) could be a pivotal system to respond to the need and responsibility of the clinician to keep up to date with latest discoveries on genetic variants and their application in a clinical setting including but not limited to hospital inpatients and outpatients; and private practice. There are a number of well validated pharmacogenomic tests that involve important information for the patient for about half of medications in current medical use. Awareness of the influence of gene variations on the way in which patients respond to certain drugs can help physicians to determine what type of drug therapy will be most effective and to avoid drugs or doses that could result in life-threatening adverse events. Examples of drugs for which adverse reactions occur in patients carrying variant genes are abacavir, carbamazepine, and antidepressants such as sertraline; examples of drugs that have sub therapeutic effects in patients with gene variations are clopidogrel, tamoxifen, and codeine and an example of a drug for which variations can alter the therapeutic dose is warfarin however there are practical barriers to initiation of such testing in a hospital or general medical practice today. Most clinicians do not have the training or the time to assess the clinical significance of genetic predisposition of a patient. To provide such as service would require the expertise of pharmacists, molecular geneticists, pathologists and associated specialists to interpret genetic results. Today in the clinical setting, there is no suitable IT tool for individualized prescribing that combines the clinical significance of drug-gene interactions as well as drug-drug interactions and the expertise from these specialists to optimise patient outcomes. Existing computer systems often do not accept incoming communications and if they do are very fixed in their display format.

Given these barriers, patients should also be able to request pharmacogenomic tests and ensure the results are accessible to authorised health care professionals involved in their treatment.

Current technology is not applicable in a clinical setting because of limitations including:
Available systems are limited to basic drug-information databases with some information on drug-drug interaction and basic information on genes involved.
Existing drug information systems are built around information on individual drugs and do not consider the drug-gene interactions of a person on multiple medications. In addition existing systems do not integrate drug-gene interactions with drug-drug interactions.
The use of specific technology is not accessible during the decision-making process by physicians and pharmacists, namely the prescription and dispensing of drugs.
Available systems are limited to case studies to demonstrate pharmacogenomic influences on commonly prescribed drugs, and pharmacogenomics drug databases
Available systems do not provide the clinicians with meaningful recommendations of what to do with the medications based on a patients genetic results e.g. if a patient has specific genetic test results how does it affect the recommendations for their drug therapy?
Available systems are supplying information based on static information from authority bodies such as the FDA or TGA which is does not take into account the many factors in prescribing, may not necessarily applicable to Australia and other parts of the world and does not provide specific guidance and advise the physician what to do. For example these systems explored importing the knowledge directly from electronic sources in the literature and as such this is less relevant and runs the risk of being irrelevant.
Furthermore it has been suggested that the information could merely be posted into the medical record as additional information to the patient's profile. This information is likely not to be available at the time the clinician is prescribing. This assumes the test and whatever report comes from it is used as the primary report the doctor uses and the electronic version is a supplementary report and may or may not be used, its timing may be such that the patient has left hospital.

With the above limitations Pharmacogenomic testing is currently delivered manually by a range of experts across different medical disciplines which represent the following challenges and considerations (See FIG. 5)
1. The report may only list the genetic result and the metaboliser category. E.g. poor metaboliser may come with a comment to change drug or decrease dose.
2. Generation of Reports is dependent on key expertise. There is limited automated clinical decision making.
3. Generation of reports are timely to generate, file and send. There is little to no integration with pathology systems and healthcare professional systems.
4. Most clinicians would not be aware of whether a test is required or what the result means and how it related to medications choice

The reference to any prior art in this specification is not, and should not be taken as, an acknowledgement or any form of suggestion that the prior art forms part of the common general knowledge.

### SUMMARY OF THE INVENTION

In one aspect of the invention there is provided a computer-implemented method, comprising: outputting by a server device a clinical decision interface, the decision interface for display by a client device; receiving by the server device information comprising: patient information and patient treatment information; processing the information to identify a preferred treatment option and recommending at least one such treatment option.

In another aspect, there is provided a computer-readable storage medium containing machine-executable instructions for outputting by a server device a clinical decision interface, the decision interface for display by a client device; receiving by the server device information comprising: patient information and patient treatment information; processing the information to identify a preferred treatment option and recommending at least one such treatment option.

In another aspect, there is provided an apparatus, comprising: a storage device; and a processor coupled to the storage device, wherein the storage device stores a program for controlling the processor, and wherein the processor, being operative with the program, is configured to cause output by a server device of a clinical decision interface, the decision interface for display by a client device; the server device adapted to receive information comprising: patient information and patient treatment information; the server device adapted to process the information to identify a preferred treatment option and recommend at least one such treatment option.

In another aspect, there is provided instructions stored on a computer readable medium, the instructions for a clinical decision method comprising a clinical decision interface, the decision interface for display by a client device; the instructions comprising receiving by the server device information comprising: patient information and patient treatment information; processing the information to identify a preferred treatment option and recommending at least one such treatment option.

In another aspect, there is provided a computer implemented method for assisting a user in a process of clinical decision making comprising: displaying a screen set soliciting a set of input data, and inputting said set of input data, wherein the data comprises patient data and patient treatment data; optionally processing the data through an algorithm to determine further content to display, input data to solicit, or modification of previous input data; displaying a recommendation based on the analysis.

In one aspect of the invention, there is provided a computer implemented method for providing clinical decision support in relation to a patient, comprising receiving patient information, receiving information about one or more options for treatment in relation to the patient, retrieving from a database information relevant to the patient information and treatment option, processing the information and creating one or more specialist recommendations for preferred treatment options.

In another aspect of the invention there is provided a system for providing computer implemented clinical support in relation to a patient comprising memory to receive patient information, memory to receive information about one or more options for treatment, a database of information relevant to types of patient information and/or treatment options and a processor to process the patient and treatment option information and create one or more specialist recommendations for preferred treatment options.

In some preferred embodiments, the patient information comprises one or more of genetic information, disease state information, historical information, lifestyle information. In some preferred embodiments, the treatment options comprise one or more of a medical intervention, medication, surgery, and/or a lifestyle change. This system could apply to other substances except for pharmaceuticals. Examples are food and environmental chemicals such as It already incorporates specific genotypes in cancer cells that determine specific treatment eg trastuzumab and HER2.

In a further aspect of the invention there is provided a system for providing a computer implemented automated clinical decision support service comprising a method for providing clinical decision support in relation to a patient, comprising receiving patient information, receiving information about one or more options for treatment in relation to the patient, retrieving from a database information relevant to the patient information and treatment option, processing the information and creating one or more specialist recommendations for preferred treatment options.

In another aspect of the invention, there is provided a computer implemented method for providing an automated clinical decision support service comprising a method for providing clinical decision support in relation to a patient, comprising receiving patient information, receiving information about one or more options for treatment in relation to the patient, retrieving from a database information relevant to the patient information and treatment option, processing the information and creating one or more specialist recommendations for preferred treatment options.

### BRIEF DESCRIPTION OF THE DRAWINGS

FIG. 1 depicts an overview of one example embodiment of the invention.

FIG. 2 is a flow diagram depicting some key functions of an example embodiment of the invention.

FIG. 3 depicts one exemplary system implementation according to the invention.

FIG. 4 is a flow diagram depicting a process flow for one example embodiment of the invention

FIG. 5 is a flow diagram depicting manual aspects of current methods.

FIG. 6 depicts the system architecture for one example embodiment.

FIG. 7 depicts a Business Domain Model according to one example embodiment of the invention.

FIG. 8 depicts an example use pathway according to one aspect of the invention.

FIG. 9 depicts an example use pathway according to one technical aspect of the invention

FIG. 10 provides a logical architecture illustrating the logical components of the system

FIG. 11 illustrates a typical prescription process within a hospital with which the system will need to integrate with and associated integration/implementation issues

FIG. 12 illustrates example processes within a hospital/clinical environment with which the invention in some embodiments must integrate with.

FIG. 13-20 provide illustrations of how an example application according to the invention may collect information from the user and present recommendations and interpretations to the end-user

FIG. 13—Homepage

FIG. 14—Order Form—Test Selection

FIG. 15—Order Form—Provision of Clinical Information

FIG. 16—Order Form—Provision—Test Request Summary and Alerting

FIG. 17—Patient Prescription Check—Patient Information

FIG. 18—Patient Prescription Check—Test Available—No Results for Patient

FIG. 19—Patient Prescription Check—Results provide contraindication for prescription of medication

FIG. 20—Patient Prescription Check—Results provide no contraindication for prescription

FIG. 21—Sample pharmacogenomic report

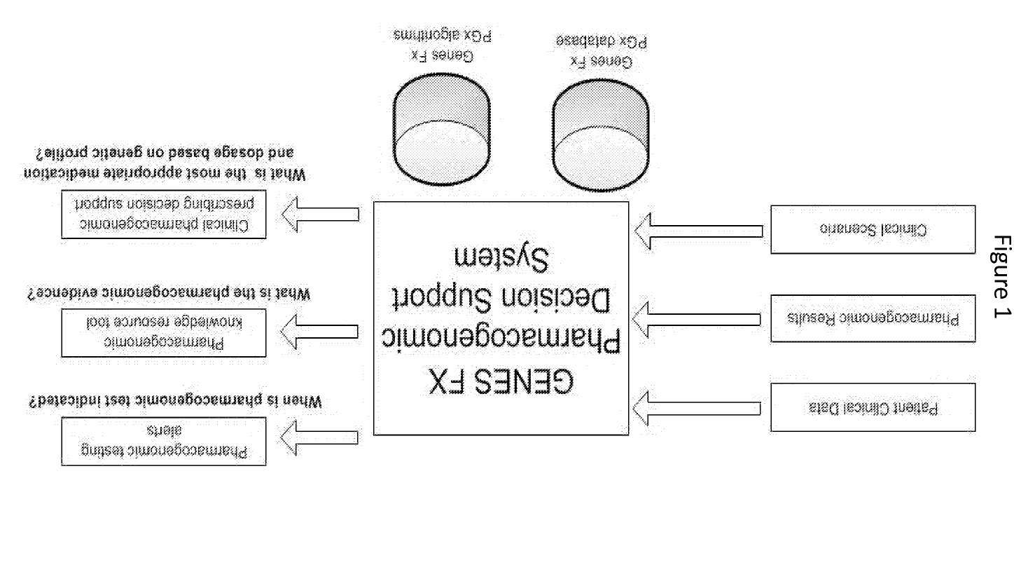

### DETAILED DESCRIPTION OF EXEMPLARY EMBODIMENTS

It is convenient to describe the invention herein in relation to particularly preferred embodiments. However, the invention is applicable to a wide range of situations and it is to be appreciated that other constructions and arrangements are also considered as falling within the scope of the invention. Various modifications, alterations, variations and or additions to the construction and arrangements described herein are also considered as falling within the ambit and scope of the present invention.

Pharmacogenomics explains how an individual's genetic make-up effects the way they respond to Medication. Recent advances in technology, now enables us to identify gene variants that can help predict possible adverse reactions or non-response in patients, prior to the prescription of specific medication.

In some embodiments, the invention delivers an end to end pharmacogenomic services helping healthcare professionals and healthcare institutions translate the benefits of pharmacogenomics into the clinic.

In some embodiments, the invention provides the ability for patients themselves to request a pharmacogenomic test and report that they can use to share information with their physician. In this instance the patient may authorise the physician to view the resultant report and the physician to then utilise the “what-if” features that are designed with the prescriber of medication in mind.

The service is based on a custom built methodology of delivering pharmacogenomic services effectively in a wide variety of healthcare settings. The service model uses a “point-of-care” framework empowering clinicians to include the genetic variations of individuals in the treatment plans when prescribing.

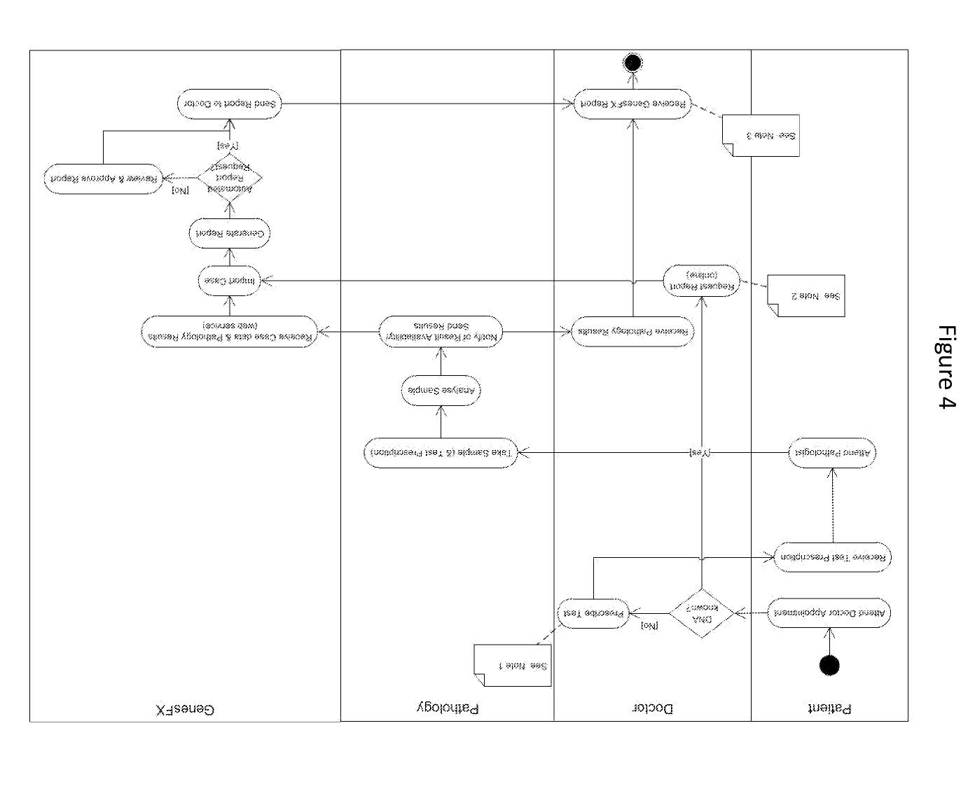

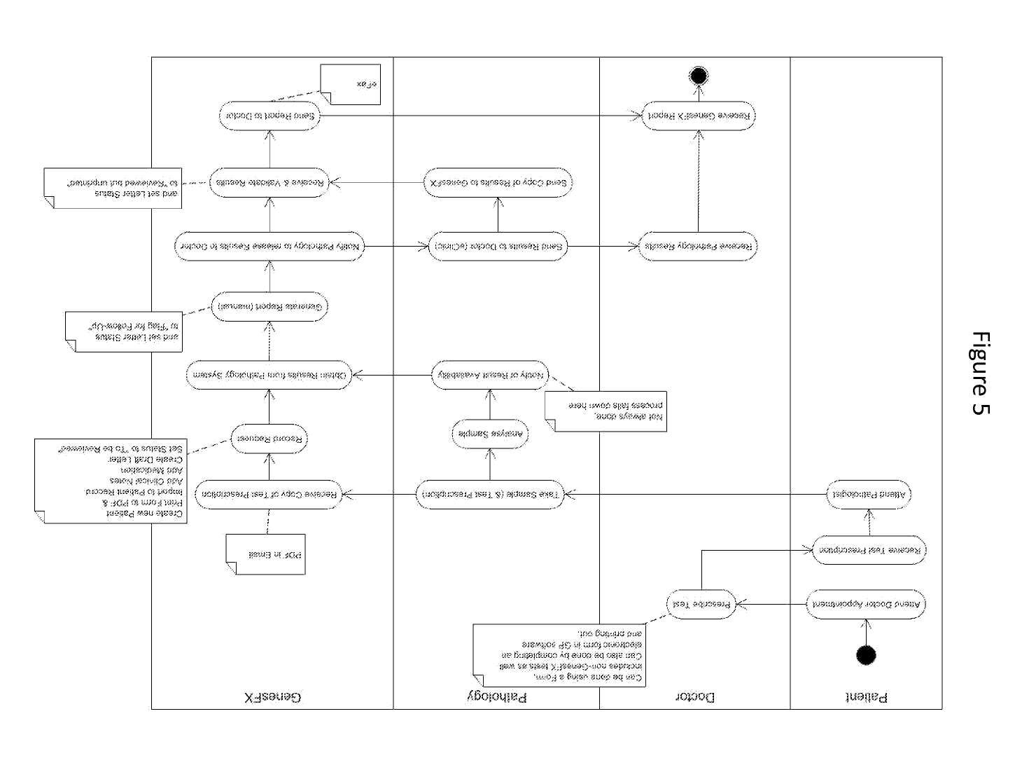

The system provides an integrated pharmacogenomic testing and interpretation service (See FIG. 4). The system identifies when pharmacogenomic tests may be appropriate and allows a physician to order pharmacogenomic tests by requesting a test for a drug or drug group. The physician does not need to know which gene test to order, but can simply request a Pharmacogenomic test based on providing the medications or types of medications to be considered.

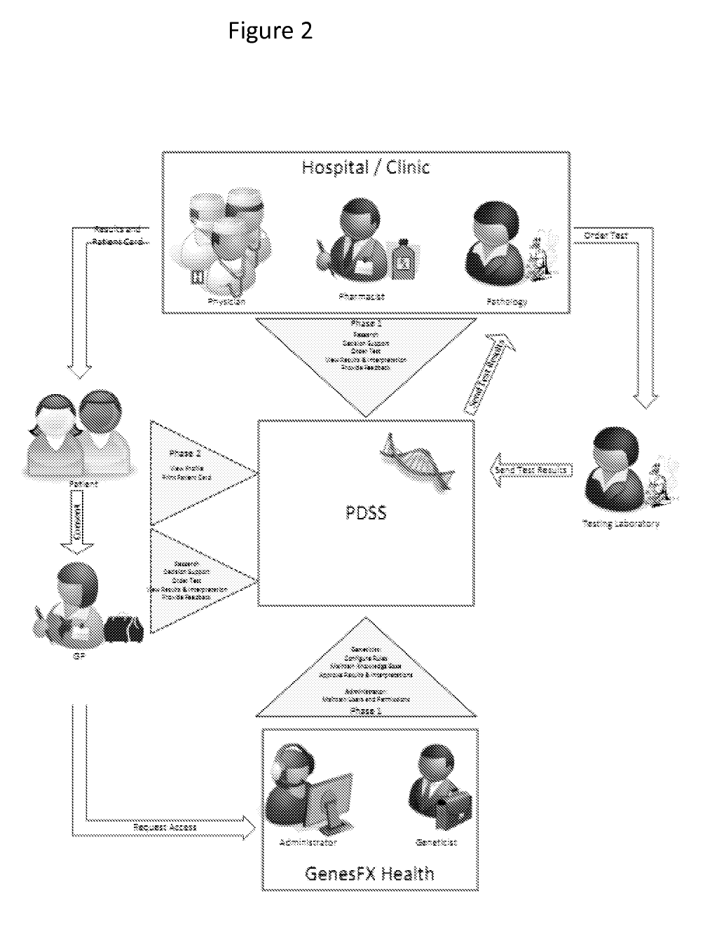

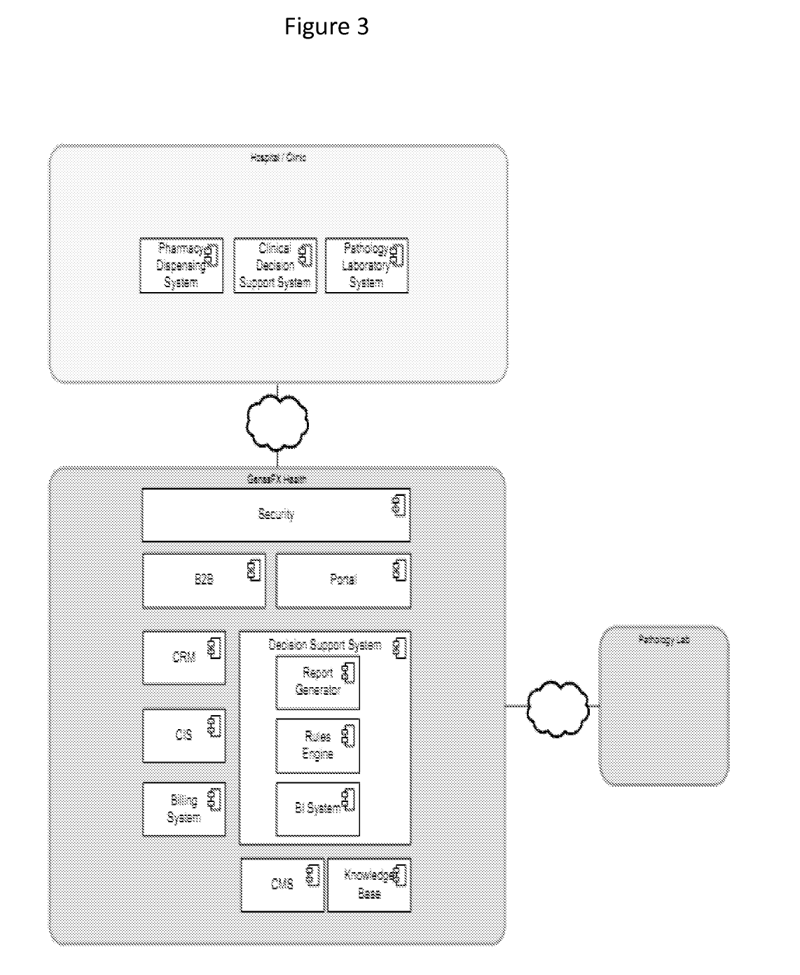

Once the test results are available the system takes the raw DNA results from the laboratory information systems and/or from point of care devices, and uses clinical decision support algorithms to interpret the genetic results and provide specific advice and clinical recommendations to the requesting physician. (See FIG. 2)

The end to end service model and software includes;
Ability to identify when pharmacogenomic testing may be appropriate
Ability to alert the users of the system when a pharmacogenomic test is recommended and provide instructions on how to order such a test
Improved communication and collaboration within the clinical environment between the pharmacists and clinicians to provide safe and effective use of medicines
Speedy access to information allowing timely decision making and greater awareness of genetic influence in drug metabolism
Suitability of use within selected areas of the hospital
Ability to incorporate pharmacogenomic results to improve safe and effective use of medicines,
Ability to link to publicly available drug-drug interaction data to provide speedy access to advice on management of the patient
Ability to link with electronic prescribing software as a means of verifying prescriptions are best suited for a patient whose genetic result is on file
Ability to receive and store pre-existing genetic data from a registered user and provide specialist report without requiring DNA collection and sequencing.

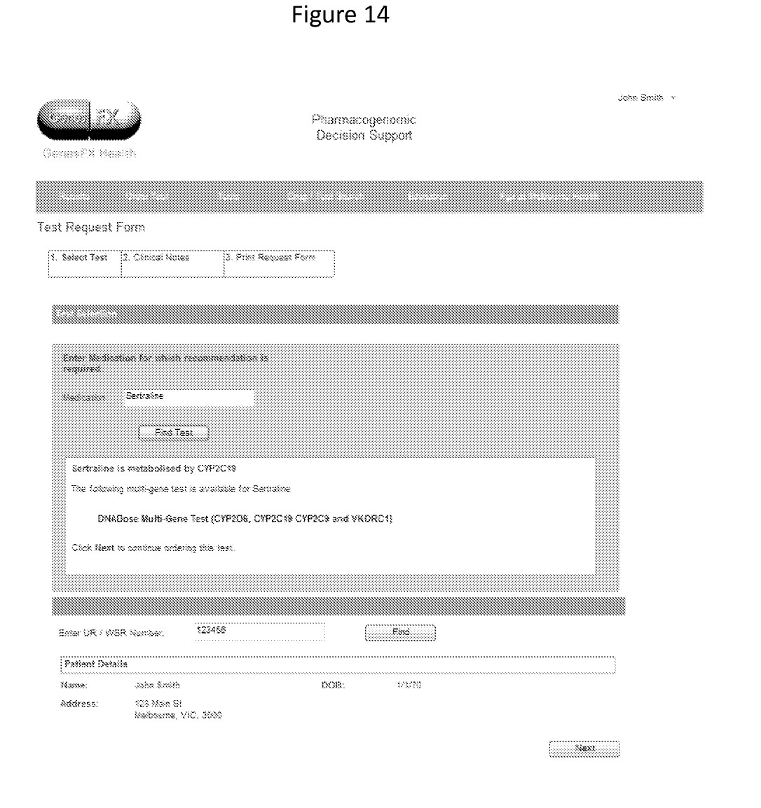

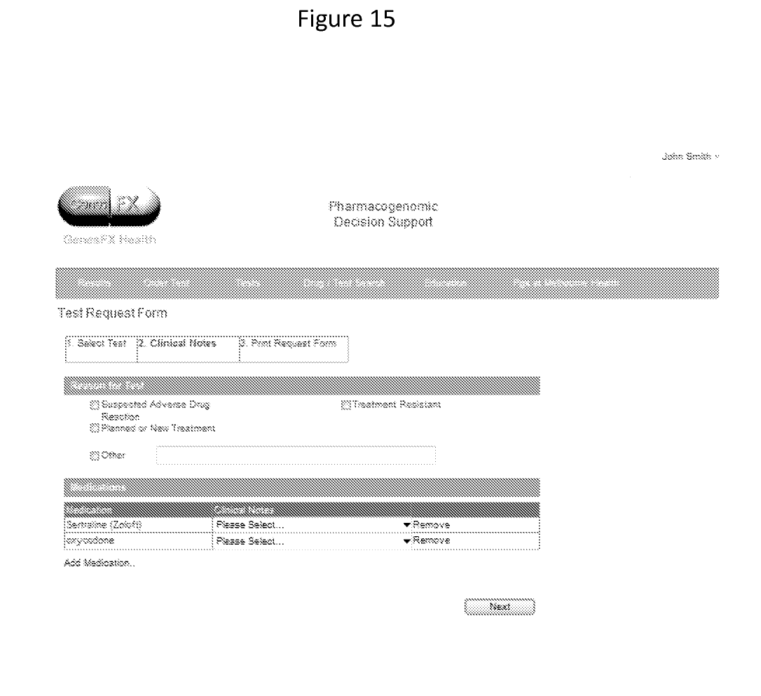

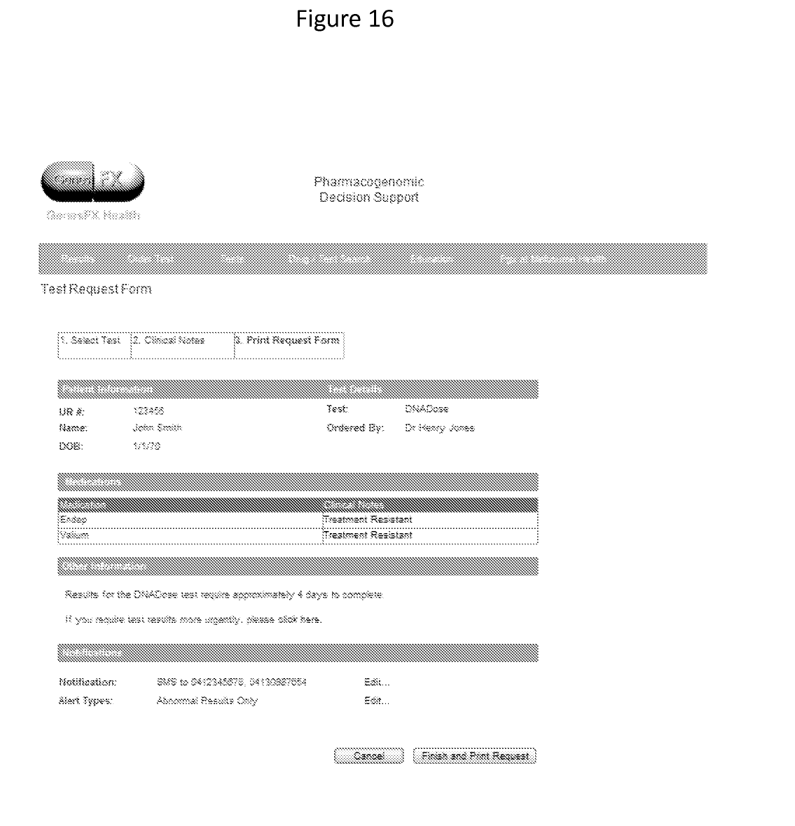

Turning to FIG. 4, currently prescribing of a DNA test is only done via a pathology form. This form is unstructured and processing must be performed to translate it into an electronic, structured form. In some embodiments of the invention, there are further methods of prescribing such tests, such as providing an online PGx request form. In such embodiments, doctors navigate to a page from within their Patient Administration System and enter Test details and required criteria. Once complete, they submit the form which sends these details to the PDSS System. At the same time a print-out of the form may be created for the patient to take with them to the pathologist (as illustrated in FIGS. 14-16).
1) In some embodiments, a report may be directly requested (without a pathology test) if one of the following is true:
   The patient already has their Pathology results stored with the system.
   The patient Pathology results are entered as part of the request.
   The patient Pathology results are stored in an electronic health record/registry external to the PDSS System and permission has been granted by patient or doctor for system to access these Pathology results.
2) If the following is true, the User may also receive the generated report almost instantaneously:
   a) The Request was sent from the online portal
   b) The user requested an automated report
   c) The Pathology results are either already held, are accessible from an electronic health record, or have been entered as part of the request.

Additionally, results may be provided to a doctor by any suitable method. For example by email, by link to a URL on a global communications network, etc. Other parties may also be provided with copies of results.

The following key functions are available for a doctor; they can be accessed via a web-based portal (PDSS web portal):

Notification/Alerting Services

The ability for clinicians to consult the system to notify or alert a doctor that a genetic test is indicated prior to prescribing a specific drug or drug class. This can be provided through the web portal without logging onto the system. One of the major barriers of incorporating Pharmacogenomics in the healthcare setting is the lack of awareness and education about the testing amongst clinicians. The system, will be able to filter the medications and alert the doctors of important drug-gene relationship by the;
the strength of evidence recommending or not recommending the test (with links to supporting literature)
the existence of any government or therapeutic bodies recommending the test both locally and overseas (such as FDA/TGA recommendations, label changes in packaged inserts)
approval/non-approval of test according to Hospital protocol for a test of a particular medication agreed upon by heads of departments.
information on how to order the test applicable

Notwithstanding, the above functionality relies on the doctor consulting the web portal at the point of prescribing. Currently in many hospitals there is still no electronic prescribing system used and a physician may prescribe a medication without consulting the system. To mitigate this risk the Pharmacy dispensing system may be configured to identify if a test is required at the point of dispensing.

DNA Analysis

DNA testing can be in any properly accredited laboratory that provides the specific tests required with a mutation detection method that covers at least 95% of the common mutations. The raw DNA results of the genetic test will be received and interpreted by the system and approved by the GenesFX expert team of clinical pharmacists and geneticists and a report produced using the system.

Reporting

The Reporting service is owned and maintained by an expert Pharmacogenomic team made up of expert clinical geneticists, molecular geneticist, clinical pharmacologists and pharmacists.

The solution is based on a flexible reporting system—a reporting system which allows interpretations to be made based on the receipt of genetic analysis data and current therapy information relevant to a given individual. The system can be extended to provide results for up to a wide variety and potentially all commonly prescribed medications thanks to its rule based structure.

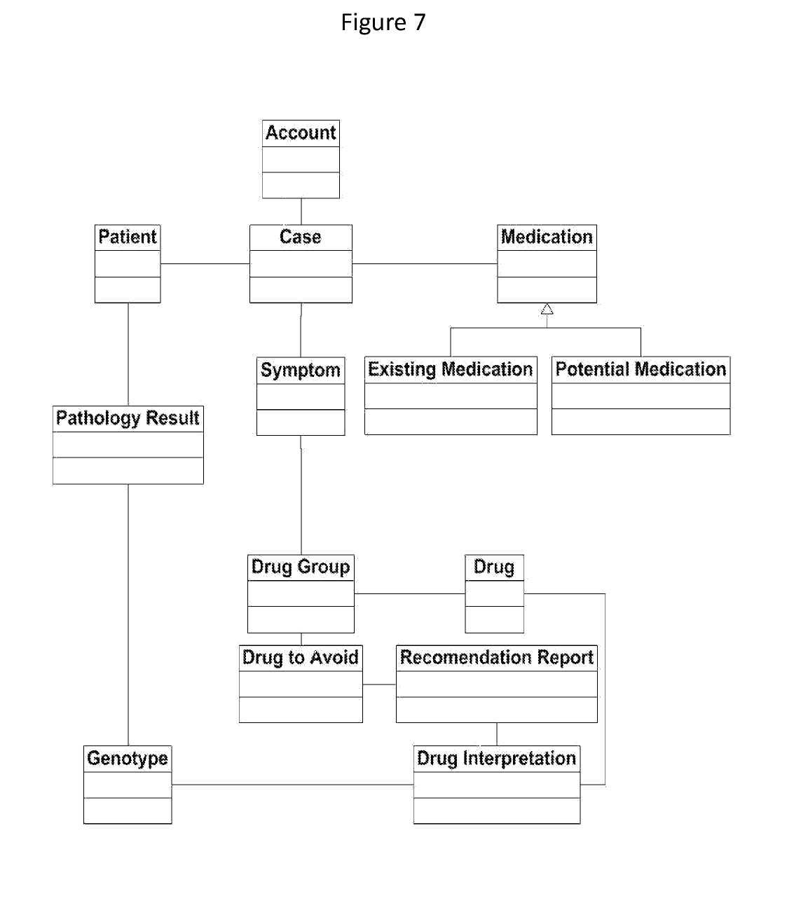

Many drugs are metabolised by more than one enzyme and many people are on more than one drug at a time. The systems looks for common variants in the multiple genes simultaneously to output specific recommendations based on many variables and rules. (See FIG. 7). The system can therefore provide the clinicians with meaningful and relevant recommendations of what to do with the medications based on a patient's genetic results e.g. if a patient has specific genetic test results how does it affect the recommendations for their drug therapy?

This system will take the raw DNA results from the laboratory test and using clinical decision support algorithms provide advice and clinical guidance. The results will be optionally available from the medical/clinical users' pathology software system and always from the GenesFX web portal

The system is able to customise the report based on each individual case. The system prepares these reports, by referring to complex rule based algorithms developed and maintained in conjunction with a clinical geneticists, pharmacists, clinical pharmacologist and specialist in their respective field.

The system looks at the genotype, the drugs used and whether the drugs use the relevant enzyme, inhibit it or induce it. The system will calculate the resulting phenotype (genotype+effect of inhibitors or inducers) and then determine what this means for the drug selection. To achieve this system has the following functionality;

### EXAMPLE ALGORITHM

In some embodiments, Pharmacogenomic Recommendation algorithm as below may be used:
a. current medication(s) AND symptoms AND planned treatment(s) AND patient information (age, height, weight) AND co-morbidities AND gene result(s) AND other factors such as smoking, diet and lifestyle factors AND drug-drug interactions
b. looks at the genotype results of the patient and calculates the degree of the enzyme function as related to normal. eg 50% Reduced Function of the gene
c. considers which drugs would be affected by this result
d. considers if any of the drugs which inhibit or induce the enzymes that are produced by the genes tested
e. then the overall function of the gene is adjusted by results of (b)
f. then drug interactions and other factors are then similarly evaluated
g. The output calculates the final function of the enzymes—along with other factors—which are then used to predict the effect of the particular drugs the patient is currently on and also any planned treatment.

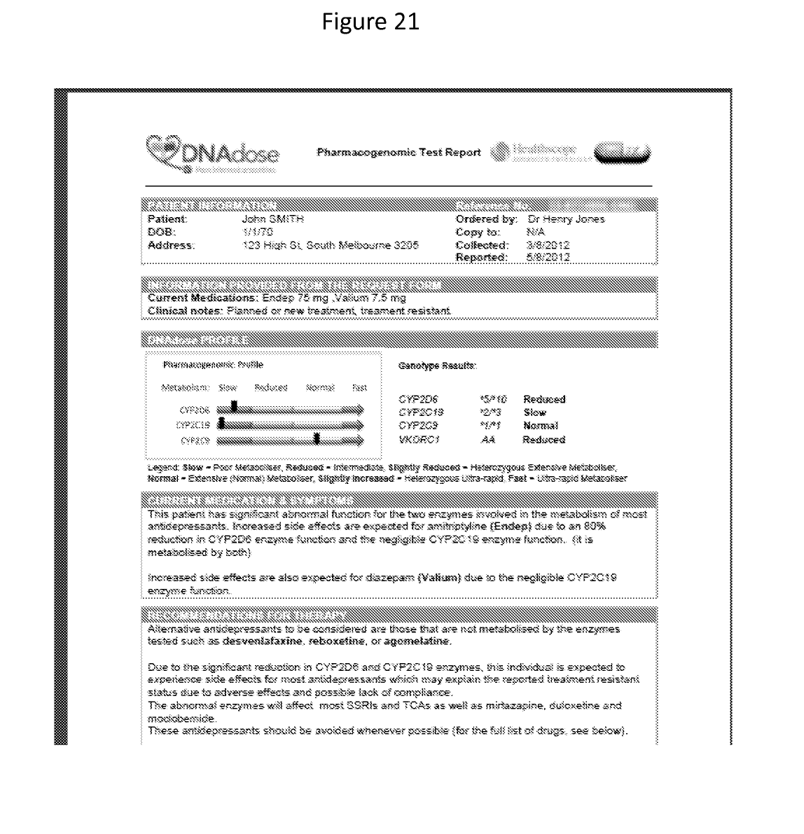

In some embodiments, there is provided an expert knowledgebase which recognizes drug classes, drug name and raw DNA results and which may provide interpretive guidelines for therapy for the patient when their relevant cytochrome genotype is known. Some embodiments enable various report types. A report can be delivered to the doctor recommending the most suitable drug and/or dose for their patient's clinical condition based on the patient's unique genetic profile (see FIG. 21).

Depending on the needs of each individual healthcare organisation (and potentially to each individual clinician) the clinical recommendations made by a system according to the invention may be reviewed and customised by the healthcare organisation to ensure they are in line with clinical protocols. If there is a problem with the recommendations the clinician may provide instant feedback to the system operator on the report as part of its quality assurance process to ensure that the recommendations are relevant.

System Overview

Some embodiments of the system have capabilities including:
Ability to consider drug specific recommendations based on a patients genetic profile, symptoms, current medications and planned medications that can be used by physicians to make fast and easy to understand decisions about treatment
Ability for a report to be generated automatically, without human intervention.
Ability to perform a simultaneous analysis of all available results from multiple genes coding for drug metabolism enzymes s including but not limited to CytochromeP450 2D6,(CYP2D6,) CYP2C19, CYP2C9, VKORC, TPMT, UGT1A1. HLA genotypes and others enzymes as the strength of evidence matures. This is especially important in light of development in technology that will allow large amounts of data to be produced that will need to be analysed by the PDSS. For example a number of commercial companies have extensive pharmacogenomics panel such as iPLEX Sequnome ADME etc.
Ability to consider scenarios where patients on polypharmacy
Ability to predict which patients will have impaired drug metabolism due to their genetic makeup.
Ability to provide personalised (individualised) medical care and information for drug and dose prescriptions.
Ability to utilise a pharmacogenomic knowledge database which links the drug-gene relationships to relevant literature, strength of evidence, known government standards/regulation
Ability to integrate drug-gene interactions with drug-drug interactions.

Recommendations/Decision Support

The ability for clinicians responsible for managing patients for whom interpretative reports have been generated to log in via The Portal and generate advice based on the patients genotype plus the use of a different drug(s). In some embodiments, this is provided through the application of the GenesFX Intelligent Forms accessed by registered providers who have logged into The Portal.

The PDSS provides the ability for physicians to make queries and perform “What if” analysis, exploring combinations of drug/gene interactions. The system allows physicians to perform this activity once actual test data is available for their patient or on data they provide into the Portal.

Patient Information

The healthcare organisation will be able to provide the patient with the PGx report as in many instances the genetic result has lifelong significance for patient with respect to future prescribing (such as a list of drugs to avoid in the future).

Security

The Physician can access the GenesFX Portal as a browser favourite link on any workstation/device with internet connectivity. The Physician can be logged in directly to the Portal via single sign-on if required

Additional System Functionality
Alerting of results availability
Alerting of topics of interest
Feedback to GenesFX
Access the Pharmacogenomic knowledgebase
Audit Trail
Click to Call
Business Intelligence
Mobility Solutions
Order Tracking

### EXAMPLE

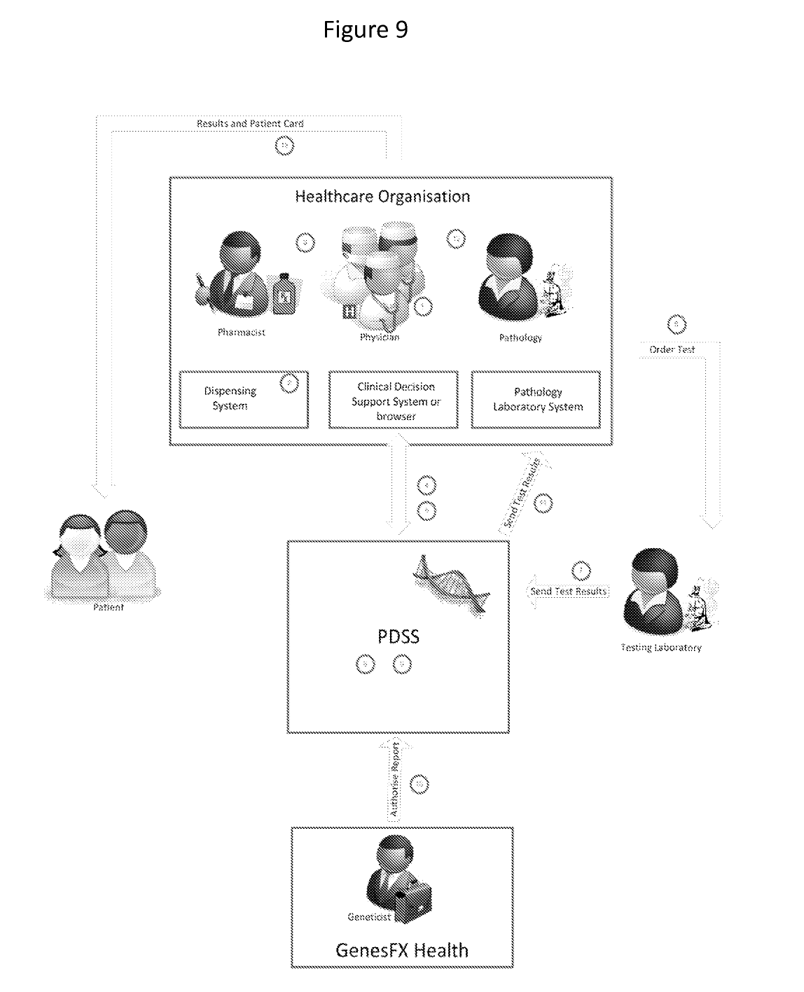

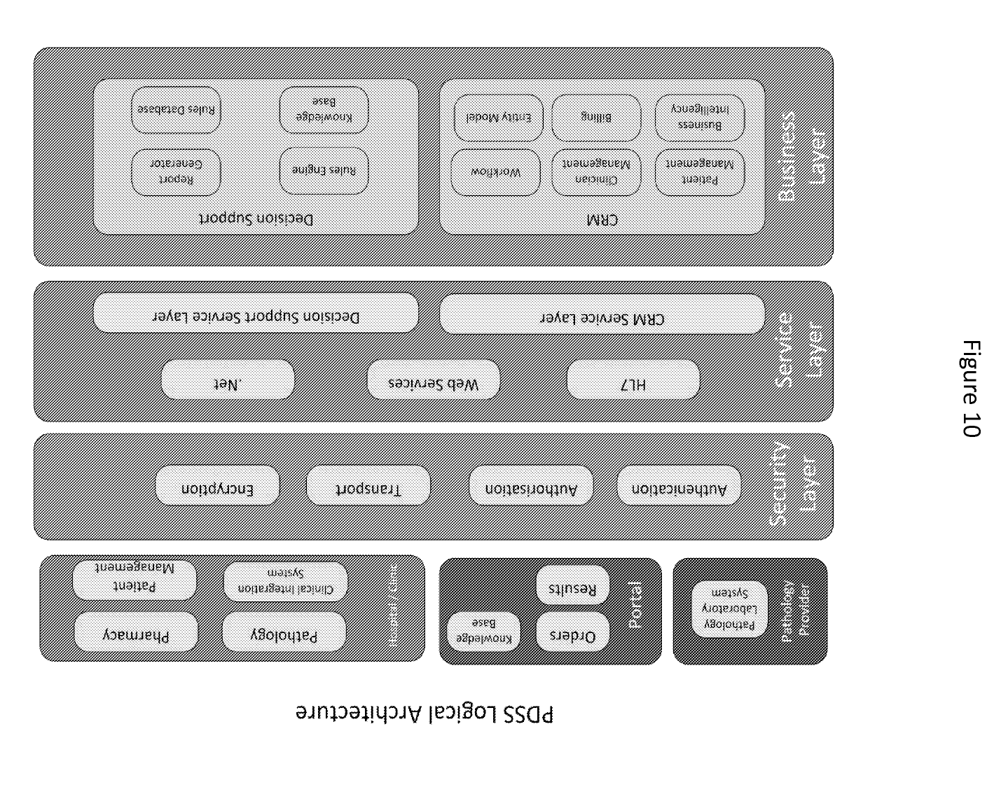

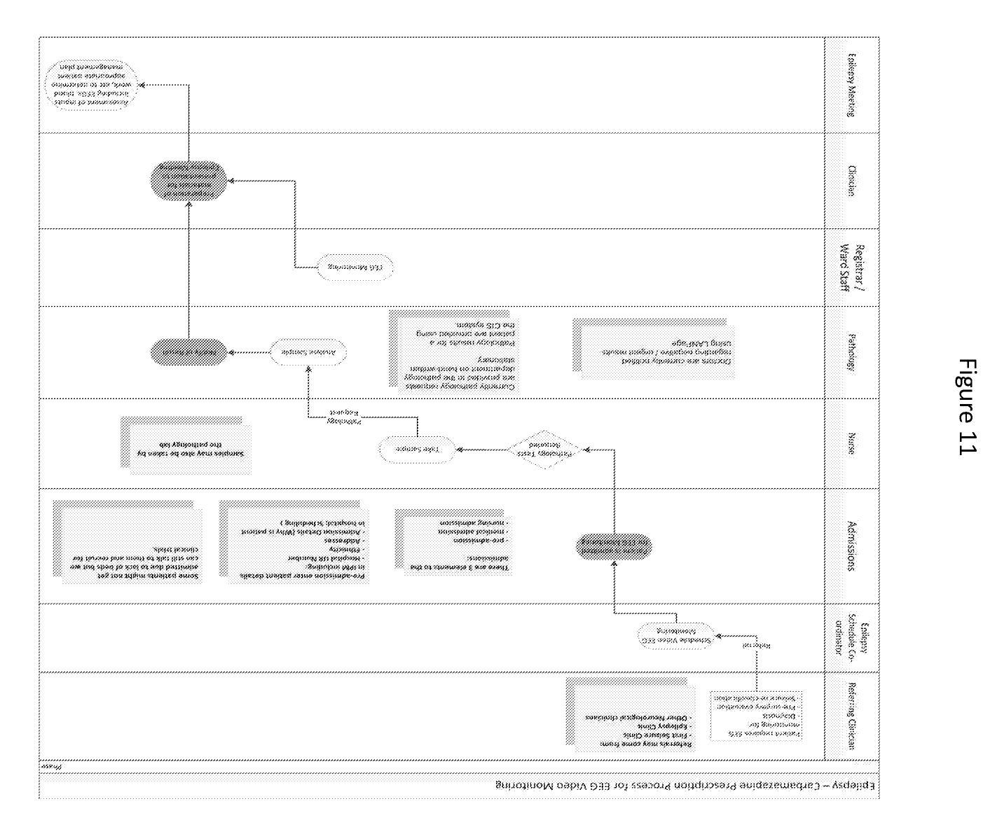

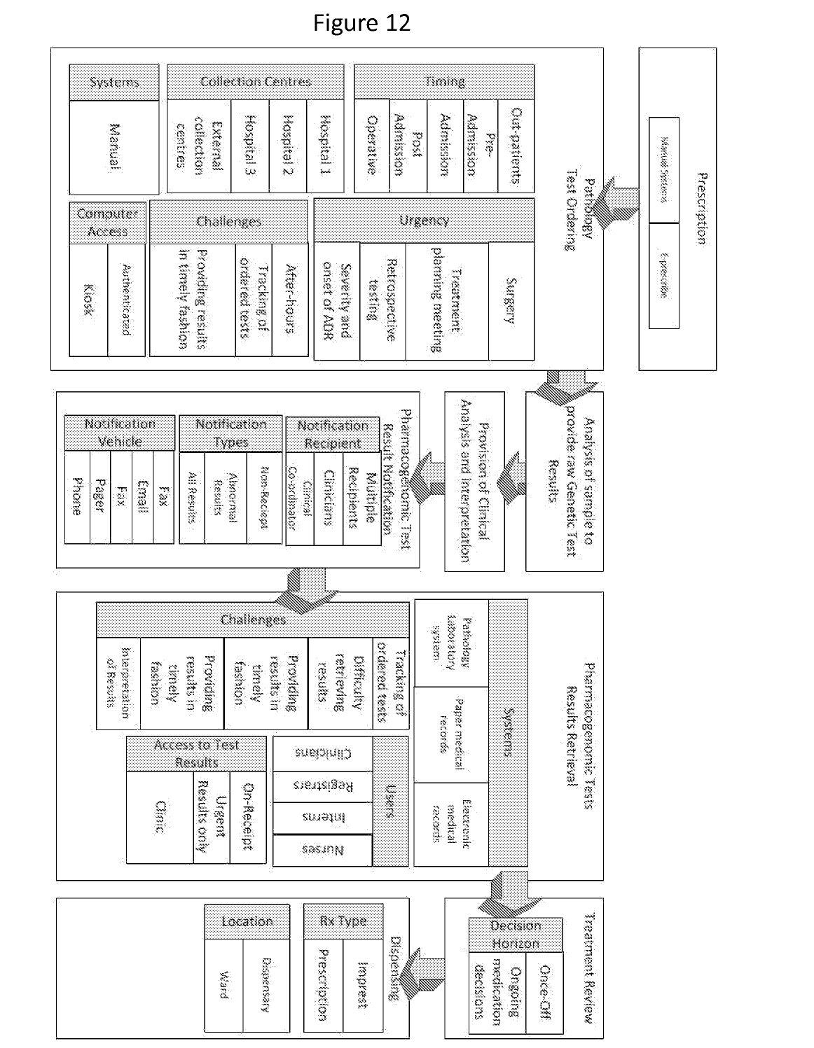

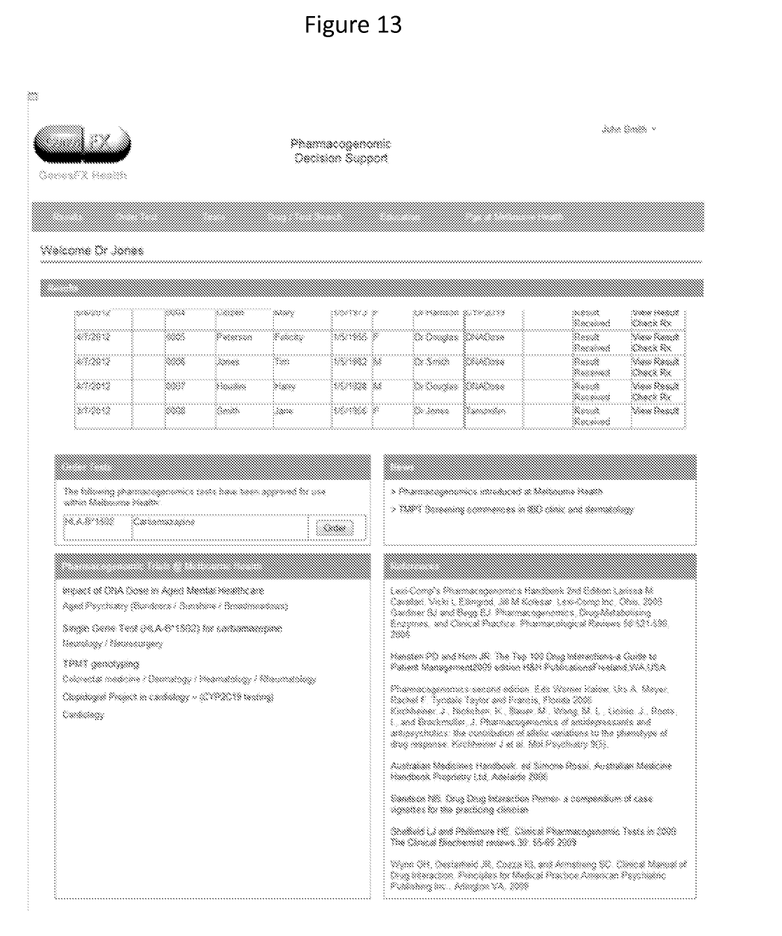

Since many drugs are metabolised by multiple enzymatic pathways, the system identifies variants in four major enzyme systems simultaneously. Together, these enzymes play an important role in metabolism and the effect of more than 50% of commonly prescribed medications [See FIG. 9]. The system results are therefore relevant for an individual throughout their lifetime and may be of benefit when prescribing the medications in FIG. 9 such as;
Antidepressants
Warfarin
Clopidogrel
Analgesics
Tamoxifen
Proton Pump Inhibitors
Anti-psychotics.

The following describes how the system works from a users perspective.

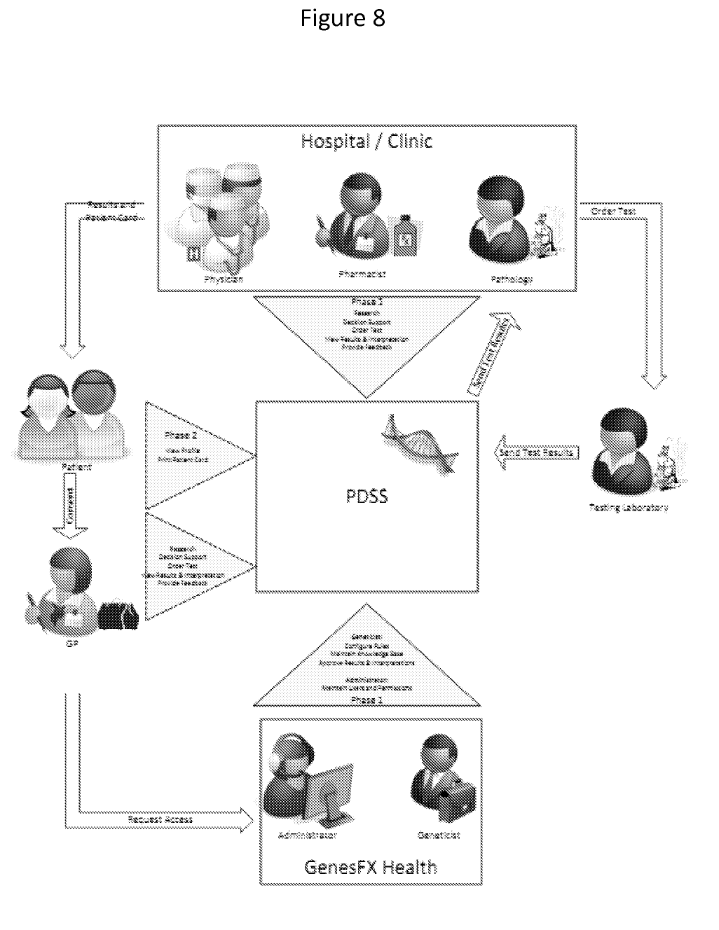

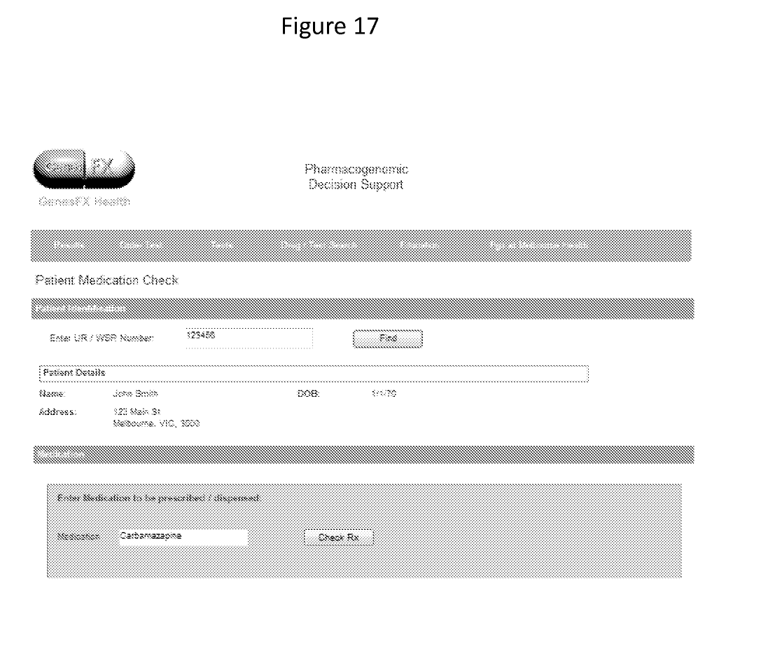

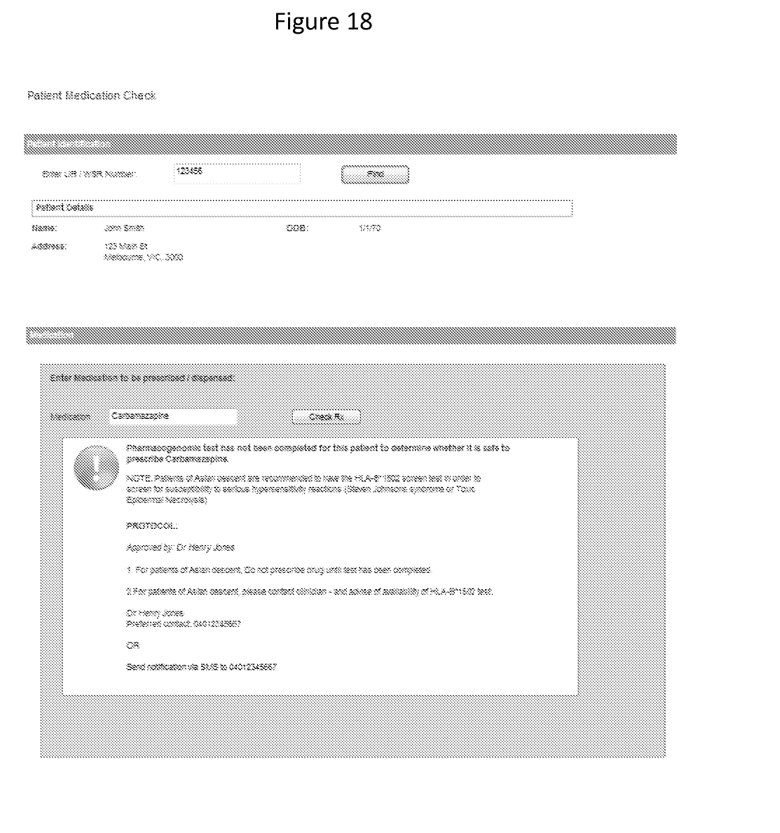

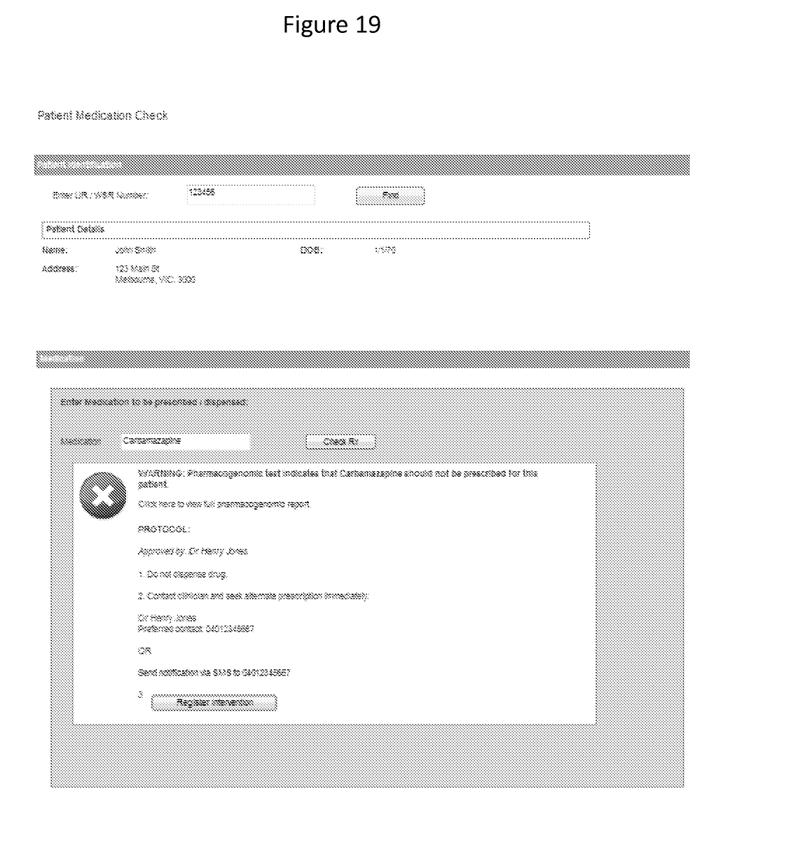

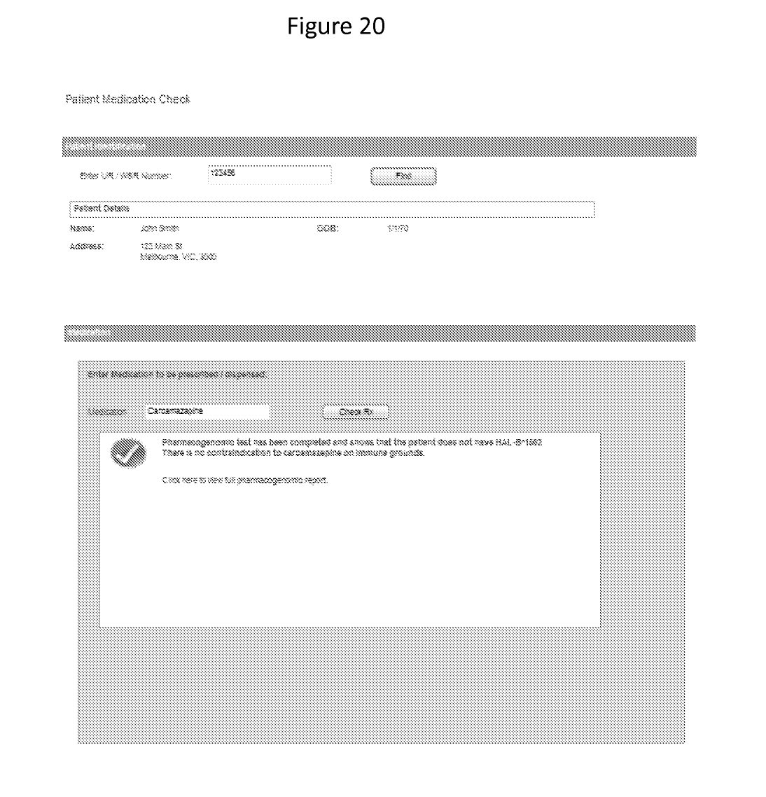

Standard Use Case for a Hospital Physician—see FIG. 8
1) Hospital doctor is treating a patient with Clopidogrel
2) Upon dispensing the drug for the patient, the Pharmacist is alerted that there is a pharmacogenomic test available for the drug. This alert has been configured into the Hospital Pharmacy dispensing system. Or alternatively is obtained through the PDSS. If pharmacogenomic test results are already available for the patient, the system will indicate whether there are contraindications and what action is to be taken (see FIGS. 17-19).
3) The Pharmacist calls the doctor and advises the test is available and asks whether the Physician wishes to do a test before dispensing the drug.
4) The Doctor decides to do some research and logs onto the GenesFX Portal via a link on the CIS patient system. The Doctor could also access the GenesFX Portal as a browser favourite link on any workstation at Hospital. Ultimately, the Doctor will be logged in directly to the Portal via single sign-on or otherwise, they will have a username and password.
5) The Doctor researches the test for Clopidogrel and finds that 24 of patients have reduced efficacy of the drug and are at increased risk of serious cardiovascular complications such as stroke and heart attack. The Doctor decides to order the CYP2C19 test.
6) The Doctor request a test (blood test or sample swab on the patient) fills in the form to order the test and sends it to Pathology. Pathology collects the sample and sends the test to the testing lab. Alternatively, the Doctor can order the test online via the Portal.
7) The testing lab performs the test and sends the result via an HL7 message to the PDSS.
8) The PDSS receives the message and enters the patient into their secure database.
9) The PDSS uses the raw test result to generate an interpretation and recommendation report.
10) The GenesFX geneticist and pharmacist review the report and authorises it to be released to the requesting clinician.
11) The PDSS sends the report to Hospital Pathology via fax or electronically in the future. Alternatively, the GenesFX Portal utilises the Hospital paging/SMS system to alert the Doctor that the test report is available.
12) Pathology enters the result in Hospital Pathology Laboratory Information System and the doctor can either views the result of the test and the recommendations made. Or, the doctor could view the test in the GenesFX Portal.
13) The doctor prints a patient summary card for the patient informing potential care-givers of the pharmacogenomic results and the important conclusions.

The following describes how the system works from a system use perspective

Standard System Use Case—see FIG. 9
1) Hospital Physician is discharging a patient and has prescribed Clopidogrel
2) Upon dispensing the drug for the patient, the Pharmacist is alerted that there is a pharmacogenomic test available for the drug. This alert has been configured into the hospital Pharmacy dispensing system using an api from the GenesFX web portal
3) The Pharmacist calls the Physician and asks whether the Physician wishes to do a test before dispensing the drug.
4) The Physician decides to do some research and links to the GenesFX Portal via the Clinical Information System. The Clinical Information System opens a browser session with the GenesFX Portal.
5) The Physician is presented with a login screen where he enters his login details for the hospital. The Security Access Management System recognises the IP address and authenticates the Physician against the hospital user store.
6) The Physician is presented with the home screen of the Portal and chooses the option to do research. The Physician enters the drug he wishes to research. The Portal extracts information from the CMS and Knowledge Base relating to the Physicians Search. He researches the test for Clopidogrel and finds that 30% of patients are resistant to the drugs and some ultra rapid metabolisers are likely to have higher blood concentrations of the active metabolite and may be more prone to bleeding events. The Physician decides to order the CYP2C19 test.
7) The Physician does a sample swab on the patient, fills in the paper form to order the test and send it to Pathology. Pathology send the test to the testing lab.
8) The testing lab performs the test and sends the result via an HL7 message to GenesFX.
9) GenesFX B2B gateway receives the message and creates a case for the patient/test.
10) GenesFX Decision Support System uses the raw test result and its rules engine to generate a interpretation
11) The Report Generator creates a recommendation report.
12) The GenesFX geneticist reviews the report and authorises it to be released to the hospital.
13) The report is stored in the CMS.
14) GenesFX faxes the report to Hospital Pathology. Pathology enter the results into the Pathology System and notify the Physician that the result is available.
15) The Physician logs into the GenesFX Portal via the Clinical Information System.
16) The Physician views the result of the test. The Portal retrieves the report from the CMS and displays it in the Portal. (see FIG. 21)
17) The Physician decides to prescribe a Prasugrel instead.
18) The Physician prints a patient card for the patient informing potential care-givers in the future that the patient should avoid Clopidogrel.

System Functions

The Pharmacogenomic Decision Support System (PDSS) provides users with fast, easy access to request Pharmacogenomic Tests and related clinical information via an online web portal for decision support model. End user access to an innovative Pharmacogenomic decision support tool that can automatically generate a medication and dosage recommendation based on an individual's DNA results and current/proposed medications.

In some embodiments, the system has capability including:
Ability to accept patient demographics, current medications, clinical history (including relevant clinical information such as symptoms, experienced side effects and suspected drug reactions) and pathology/genetic test results
Ability to identify when pharmacogenomic testing may be appropriate
Ability to alert doctors when a pharmacogenomic test is recommended and provide instructions on how to order such a test
Ability to provide the results of genetic testing with expert analysis, advice and recommendations regarding the most appropriate medication and dosage for the patient
Ability to provide genetic testing findings and recommendations in a structured report
Ability to provide evidence-based guidance to doctors about the clinical significance of pharmacogenomics tests
Ability to integrate or link with existing information systems such as Pharmacy dispensing, Pathology and other physician medical support systems
Ability to integrate or link with future clinical information systems such as electronic health record, personal medical records, e-prescribing, pharmacy dispensing systems and order entry software
Ability to be functional across a range of healthcare environments such as hospitals, general practitioners, specialists and pharmacies.
Ability to support integration with government health initiatives such as the Personally Controlled electronic Healthcare Record
Ability to provide a facility for doctors to request and obtain the Pharmacogenomic report from a mobile device.
Ability to deliver reports seamlessly and securely to all appropriate channels including but not limited to fax, email and online portal..
Ability to provide workflow for the generated reports, so that they proceed through an approval step.
Ability to provide a facility for doctors to request and obtain the Pharmacogenomic report from a web
Ability to support the ability for reports to be requested for a patient that already has their DNA Assessment held by GenesFX portal. These requirements are summarised below:

| Requirement | | Description |
|---|---|---|
| 1. | Alerts | 3 example types of Alerting |

| | |
|---|---|
| 1) | Notify or alert a doctor or pharmacists that a genetic test |
| | is indicated prior to prescribing a specific drug or drug |
| | class |
| 2) | Users can subscribe for notifications to receive alerts for |
| | how they wish to receive results. For example, a user |
| | can set alerts to receive SMS for all abnormal results for |
| | a specific gene test, and emails for all normal results. |
| 3) | Notifications can also be configured in so that a user can |
| | be notified of changes and updates to articles or subject |
| | areas of interest. |

| | | |
|---|---|---|
| 2. | Generate | An innovation of the PDSS is that test interpretations are |
| | Recommendation | formalised and encoded into rule-sets that are activated to |
| | Report | allow the system to generate interpretations automatically |
| | | once genetic test results are received. |
| 3. | Recommendation | PDSS generates recommendation reports for cases where |
| | Report Approval | rules determine the report text. Workflow is required so that |
| | | auto-generated reports can be reviewed by the GenesFX |
| | | staff before being released for viewing to the requesting |
| | | doctor. |
| 4. | Decision Support | The PDSS provides the ability for doctors to make queries |
| | | and perform “What if” analysis, exploring combinations of |
| | | drug/gene interactions and any relevant drug-drug |
| | | interactions. The system allows doctors to perform this |
| | | activity once actual genetic test result data is available for |
| | | their patient or on patient data they provide into the Portal. |
| 5. | Security | Where the primary user relationship is with an institution |
| | | such as a Hospital, the Physician is be able to be logged in |
| | | directly to the Portal via single sign-on (i.e. the same user |
| | | name used for internal hospital applications) so as to provide |
| | | a seamless extension to the institutions own internal |
| | | systems. |
| | | In other environments, The PDSS provides fully functional |
| | | web security; including |
| | | Adding users and assigning initial passwords |
| | | Assigning permissions to PDSS functionality |
| | | Allowing users to login to the system |
| | | Allowing users to change their passwords |
| | | Controlling access to functionality and reports based |
| | | on permissions and access rights |
| | | Data is encrypted in transmission and storage |
| 6. | Knowledgebase | The GenesFX Pharmacogenomic Knowledgebase is kept up |
| | | to date with the latest evidence and clinical relevance of |
| | | Pharmacogenomics to increase clinical guidance and |
| | | demonstrate the value of Pharmacogenomics with |
| | | prescribing. |
| | | The PDSS provides a comprehensive knowledge base of |
| | | information regarding genetic testing services, drug/gene |
| | | interactions and gene/symptoms. |
| | | A comprehensive study of the available medical literature is |
| | | available to assist doctors to improve the quality of the care |
| | | of their patients. This includes access to clinical protocols for |
| | | prescribing medications that require a Pharmacogenomic |
| | | Test |
| | | Features: |

| | |
|---|---|
| a) | User is able to search on drug name, test name and |
| | symptom |
| b) | User selects to view knowledge base content relating |
| | to a test recommendation report being viewed |

| | | |
|---|---|---|
| 7. | Ordering | Provides Doctors with online ordering capability to ensuring |
| | Pharmacogenomic | the correct gene test is ordered and sent through the |
| | Tests | appropriate pathology process. These test requests are then |
| | | sent directly into the pathology system, (see FIGS. 14-16) |
| | | Automation of complex pharmacogenomic test request |
| | | process including workflow tasks associated ascertaining if |
| | | patient already has a genetic profile on file and if not ordering |
| | | such testing |
| | | A catalogue with a shopping cart function that allows the user |
| | | to order supported or approved genetic tests. PDSS |
| | | interfaces to subscribing paging tools and can also trigger |
| | | automated delivery of requests upon approval. |
| 8. | View Results and | Once a genetic test has been completed by the testing lab, |
| | Interpretation | the PDSS generates the pharmacogenomics interpretation |
| | | report. Once the report is reviewed and approved, it is |
| | | available to be viewed. The report is available to the |
| | | requesting physician, doctors in the requesting hospital and |
| | | any private doctors where the requesting physician has |
| | | authorised them to review results during the clinical care |
| | | process, (see FIG. 21) |
| 9. | View Report | Audit trail of all clinical activity on the system is recorded in a |
| | Activity Audit | read only audit trail that can be accessed by the PDSS |
| | Log | Administrator |
| 10. | Provide | The system allows the requesting physician to optionally |
| | Feedback | provide feedback from the interpretation reports which can be |
| | | used to improve the service to the physician. |
| 11. | Business | Standard and custom generated management reporting. |
| | Intelligence | Enabling further research projects, measure improved |
| | | compliance with quality use of medicines and associated cost |
| | | benefits |
| 12. | Click-to-call | Click to call unified communications to talk directly to |
| | | Pharmacogenomic Support Centre. Eg Live chat to geneticist |
| 13. | Mobile | Access to PDSS including decision support functionality to |
| | Applications | mobile devices will be developed as an extension of the |
| | | portal application and/or a mobile-specific set of |
| | | functionality. |

The following table provides a list a summary of Functionality of the System

| Requirement | | Use | |
|---|---|---|---|
| 1. | Research | a) | User selects to view knowledge base content |
| | | | relating to a test recommendation report being |
| | | | viewed |
| | | b) | User selects to view knowledge base content |
| | | | from search results |
| 2. | Ordering | a) | User orders genetic test |
| | Pharmacogenomic | b) | User prints order form |
| | Tests | c) | GenesFX accepts electronic order via |

| | |
|---|---|
| a. | HL7 message generated |
| b. | Webservice |

| | |
|---|---|
| d) | User views the status of an order |
| e) | GenesFX sends result to other system via |

| | |
|---|---|
| a. | HL7 |
| b. | PDF upload |
| c. | Webservice |

| | | | |
|---|---|---|---|
| 3. | View Results and | a) | User selects to view test recommendation report |
| | Interpretation | | from search results |
| | | b) | User selects to print test recommendation report |
| | | c) | User selects to download a recommendation report |
| | | | in PDF format |
| | | d) | User selects to change variables relating to patient |
| | | | to view recommendations based on additional |
| | | | information |
| 4. | Decision Support | a) | Ad hoc query once result obtained |
| 5. | Generate | a) | System generates test recommendation report from |
| | Recommendation | | raw test result |
| | Report | b) | System generates Patient report, detailing GenesFX |
| | | | patient number and recommendations of drugs to |
| | | | avoid |
| | | c) | System generates Patient Card |
| 6. | Alerts | a) | GenesFX publish alerts when tests are available for |
| | | | particular drugs via |

| | |
|---|---|
| a. | HL7 |
| b. | Webservice |

| | | | |
|---|---|---|---|
| 7. | Search | a) | User searches for test recommendations by: |

| | |
|---|---|
| i. | patient surname, |
| ii. | patient first name, |
| iii. | patient DOB, |
| iv. | Healthcare provider id number, |
| v. | Healthcare provider |
| vi. | GenesFX provider id, |
| vii. | GenesFX result number, |
| viii. | physician first name and/or |
| ix. | physician surname |

| | |
|---|---|
| b) | User searches for test recommendations via |
| | chronological, date ordered list |
| c) | User searches for test recommendations via |
| | reverse-chronological, date ordered list |
| d) | User searches knowledge base by drug generic |
| | name |
| e) | User searches knowledge base by drug product |
| | name |
| f) | User searches knowledge base by drug therapeutic |
| | class |
| g) | User searches knowledge base by test name |
| h) | User searches knowledge base by gene |
| i) | User searches knowledge base by condition/disease |

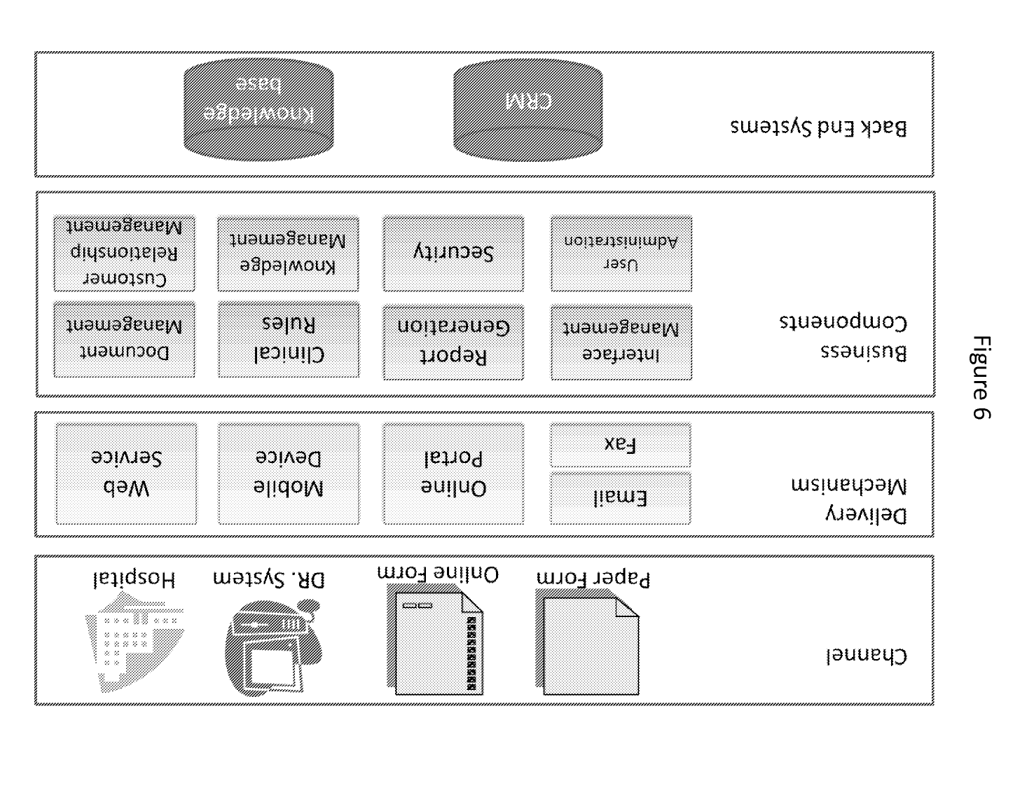

Turning to FIG. 6, which depicts the system architecture for one example embodiment. The following table provides further information.

Channel Layer

| Channel | Description |
|---|---|
| Paper | All Cases are typically currently initiated by Paper |
| Form | Form. In addition, a specialised PGx form will be |
| | available. |
| Online | An Online form that is available through the portal in |
| Form | either a logged-in mode or not logged-in mode. Allows |
| | the user to also specify whether a test is required or |
| | whether pathology results are known (whether they are |
| | held or if they will provide in the request). |
| Doctors' | The Doctor's Patient Administration System. There are |
| System | two options here; either the PAS is fully integrated |
| | and communicated with the GenesFX System via a web |
| | service, or it has an embedded web page/link to the |
| | online portal. |
| Hospital | The Hospital's Patient Administration System.¹ There |
| System | are two options here; either the PAS is fully |
| | integrated and communicated with the GenesFX System |
| | via a web service, or it has an embedded web page/link |
| | to the online portal. |

Delivery Mechanism Layer

| Delivery | |
|---|---|
| Mechanism | Description |
| Email | The typical current mechanism for receiving pathology |
| | reports. Paper forms are scanned as a PDF by the |
| | pathologist and then emailed to GenesFX. Ultimately, |
| | it would be ideal to remove this mechanism, but it |
| | may still be required for Doctors and Pathologists |
| | that are not able to transition to the new mechanisms. |
| Fax | The current mechanism for sending Reports to Doctors. |
| | Ultimately, it would be ideal to remove this |
| | mechanism, but it may still be required for Doctors |
| | and Pathologists that are not able to transition to |
| | the new mechanisms. |
| Online | A web application that Doctors would log in to in |
| Portal | order to request reports for their patients. |
| Mobile | A mobile solution that would be available to Doctors |
| Device | in the same manner that the Online Portal is |
| | available. |
| Web | The mechanism for receiving requests and sending |
| Service | reports to allow for full integration with external |
| | parties' systems. |

Business Component Layer

| Business | |
|---|---|
| Component | Description |
| Interface | Manages the interfaces with external systems and |
| Management | the data processing to support importing of Cases. |
| Report | Generates the Pharmacogenomic Reports based on |
| Generation | Clinical Rules. This component may be provided |
| | either in conjunction with the Clinical Rules |
| | component or as a simple Report Generation tool. |
| Clinical | This component houses all the rules that are used |
| Rules | to automatically generate a report. This component |
| | may be provided by a stand-alone Business Rules |
| | Engine or may be couple with the Report Generation |
| | tool. |
| Document | Manages the documents that are generated and held |
| Management | by GenesFX. |
| User | Manages the Users for the online portal and |
| Administra- | potentially the web services. |
| tion | |
| Security | Manages the security of the online portal and web |
| | services. |
| Knowledge | Contains content that is used in the report |
| Management | generation and online services. |
| Customer | Contains the details of the Accounts, Cases and |
| Relationship | Patients, amongst other things as well as the |
| Management | relationships between them. |

Back End System Layer

| Object | Description |
|---|---|
| CRM | The database to support the Customer Relationship |
| | Management component. |
| Knowledgebase | The data store to support the Knowledge |
| | Management Component, potentially the Document |
| | Management Component as well. |

Turning now to FIG. 7:
Objects forming Account, Patient, Case, Medication, and Symptom comprise information that is sourced from the prescribing Doctor or report requester.
Objects Pathology Result, Genotype comprise information sourced from the pathologist.
Objects other than those described in the previous 2 points comprise information that is generated by GenesFX.

| Object | Description | |
|---|---|---|
| Account | An Account is an entity that GenesFX interacts with and | |
| | initiates Report requests. Eg. Doctor, Hospital. | |
| Case | A Case is opened for each new request for a report. | |
| Patient | A Patient is the entity that the report is being generated | |
| | upon. The patient supplies a sample for the DNA | |
| | Assessment. | |
| Symptom | A Symptom relates to a specific drug group and is a | |
| | selectable list (not free-entry). For example: | |
| | Symptom | Drug Group |
| | No Response | Anti-Depressant |
| | Side Effect | Anti-Depressant |
| | No Response | Pain Killer |
| | Vomiting | Pain Killer |

| | |
|---|---|
| Medication | Medication is specified for a patient in a Case. There are |
| | two types of medication, identified below. |
| Existing | Medication the patient is currently on. |
| Medication | |
| Potential | Medication the doctor is considering prescribing for the |
| Medication | patient. |
| Pathology | The result of genetic testing of a patient that is generated by |
| Result | the pathology lab. As a pathology result will never change |
| | for a patient it is held against the patient rather than the |
| | Case. |
| Genotype | One gene assessment that is included in the pathology |
| | result. |
| Drug | A drug that is available on the market that has a gene |
| | interaction. |
| Drug Group | A grouping of drugs that are used to treat a particular |
| | affliction. For example, Antidepressants. |
| Recommendation | Generated by GenesFX for a particular case, that contains a |
| Report | number of recommendations. |
| Drug to Avoid | Based on a Symptom/Drug Group, a recommendation is |
| | provided for drugs that should be avoided. |
| Drug | Based on a genotype and associated medication, a drug |
| Interpretation | interpretation is provided. |

The system and method of the invention is useful in a wide range of situations and for example in relation to a wide range of medications. The following lists of drugs are examples only:

As an example, below is a list of drugs (substrates) that are metabolised by specific CYP450 enzymes that the system can provide Pharmacogenomic Information and Interpretation for.

| CYP2C19 | CYP2C9 | CYP2D6 |
|---|---|---|
| Proton Pump Inhibitors: | NSAIDs: | Antidepressants: |
| esomeprazole | diclofenac | amitriptyline |
| lansoprazole | Ibuprofen | clomipramine |
| omeprazole | indomethacin | dothiepin |
| pantoprazole | meloxicam | doxepin |
| rabeprazole | naproxen | duloxetine |
| Anti-epileptics: | piroxicam | fluoxetine |
| diazepam | Angiotensin II | fluvoxamine |
| phenobarbitone | Blockers: | imipramine |
| Antidepressants: | irbesartan | mirtazapine |
| amitriptyline | losartan | nortriptyline |
| citalopram | Sulfonylureas: | paroxetine |
| clomipramine | glibenclamide | trimipramine |
| dothiepin | gliclazide | venlafaxine |
| doxepin | glimepiride | Antipsychotics: |
| escitalopram | glipizide | aripiprazole |
| fluvoxamine | Others: | chlorpromazine |
| imipramine | celecoxib | haloperidol |
| moclobemide | fluoxetine | risperidone |
| sertraline | fluvastatin | zuclopenthixol |
| trimipramine | montelukast | Beta Blockers: |
| Others: | phenobarbitone | carvedilol |
| clobazam | phenytoin | metoprolol |
| clopidogrel | primidone | propranolol |
| cyclophosphamide | rosiglitazone | timolol |
| flunitrazepam | warfarin | Opioid |
| gliclazide | zafrilukast | Analgesics: |
| indomethacin | | codeine |
| nelfinavir | | oxycodone |
| nilutamide | | tramadol |
| phenytoin | | Others: |
| primidone | | atomoxetine |
| proguanil | | chlorpheniramine |
| propranolol | | dexamphetamine |
| teniposide | | dextromethorphan |
| | | flecainide |
| | | metoclopramide |
| | | ondansetron |
| | | perhexiline |
| | | proguanil |
| | | promethazine |
| | | tamoxifen |
| | | tropisetron |

Inhibitors

Inhibitors bind to the enzyme and reduce the enzyme activity in metabolising the substrate (drug). A strong inhibitor greatly decreases the amount of drug metabolised. This may lead to an increase in side effects for active drugs and a decrease in effect for pro-drugs. Weak inhibitors have a minimal effect on this process; therefore they are not included in the list below.

Strong and moderate inhibitors are listed below according to the specific enzyme they inhibit:

| CYP2C19 | CYP2C9 | CYP2D6 |
|---|---|---|
| dothiepin | fluconazole | chlorpromazine |
| fluconazole | ibuprofen | fluoxetine |
| fluvoxamine | indomethacin | paroxetine |
| isoniazid | ketoconazole | terbinafine |
| modafinil | piroxicam | amiodarone |
| omeprazole | sildenafil | cimetidine |
| ticlopidine | sulfamethoxazole | clomipramine |
| voriconazole | voriconazole | diphenhydramine |
| cimetidine | amiodarone | duloxetine |
| fluoxetine | fenofibrate | haloperidol |
| ketoconazole | fluvastatin | imipramine |
| lansoprazole | losartan | ketoconazole |
| rabeprazole | omeprazole | metoclopramide |
| sertraline | pantoprazole | promethazine |
| | warfarin | sertraline |
| | zafirlukast | ticlopidine |

Inducers

Inducers stimulate the production of an enzyme which increases the rate of metabolism of a drug. Examples of enzyme inducers are listed below:

| CYP2C19 | CYP2C9 | CYP2D6 |
|---|---|---|
| carbamazepine | carbamazepine | — |
| phenytoin | phenobarbitone | — |
| prednisone | phenytoin | — |
| rifampicin | primidone | — |
| | rifampicin | |

1-8. (canceled)

9. A computer-implemented method, comprising:
outputting by a server device a clinical decision interface, the decision interface for display by a client device;
receiving by the server device information comprising patient information and patient treatment information; and
processing the information to identify a preferred treatment option and recommending at least one such treatment option.

10. A method according to claim 9 wherein the patient information comprises one or more of genetic information, disease state information, historical information, lifestyle information.

11. A method according to claim 9 wherein the treatment option comprises one or more of a medical intervention, medication, surgery, and/or a lifestyle change.

12. A method according to claim 9 wherein the clinical decision is in relation to one or more of a pharmaceutical treatment, a surgical treatment, a radiation treatment, a lifestyle modification, a food modification, a traditional medicine treatment or the like.

13. An apparatus comprising:
a storage device; and
a processor coupled to the storage device, wherein the storage device stores a program for controlling the processor, and wherein the processor, being operative with the program, is configured to cause output by a server device of a clinical decision interface, the decision interface for display by a client device; the server device adapted to receive information comprising: patient information and patient treatment information; the server device adapted to process the information to identify a preferred treatment option and recommend at least one such treatment option.

14. An apparatus according to claim 13 wherein the patient information comprises one or more of genetic information, disease state information, historical information, lifestyle information.

15. An apparatus according to claim 13 wherein the treatment options comprise one or more of a medical intervention, medication, surgery, and/or a lifestyle change.

16. An apparatus according to claim 13 wherein the clinical decision is in relation to one or more of a pharmaceutical treatment, a surgical treatment, a radiation treatment, a lifestyle modification, a food modification, a traditional medicine treatment or the like.

17. A computer implemented method for assisting a user in a process of clinical decision making comprising:
displaying a screen set soliciting a set of input data,
inputting said set of input data, wherein the data comprises patient data and patient treatment data; optionally processing the data through an algorithm to determine further content to display, input data to solicit, or modification of previous input data; and
displaying a recommendation based on the processing.

18. A method according to claim 17 wherein the patient information comprises one or more of genetic information, disease state information, historical information, lifestyle information.

19. A method according to claim 17 wherein the treatment options comprise one or more of a medical intervention, medication, surgery, and/or a lifestyle change.

20. A method according to claim 17 wherein the clinical decision is in relation to one or more of a pharmaceutical treatment, a surgical treatment, a radiation treatment, a lifestyle modification, a food modification, or a traditional medicine treatment.
